(19) United States
(12) Patent Application Publication
(10) Pub. No.: US 2026/0367303 A1
(43) Pub. Date: Nov. 19, 2026

(54) Reflective Polarizer and Optical Construction

(71) Applicant: 3M INNOVATIVE PROPERTIES COMPANY, St. Paul, MN (US)

(72) Inventors: Adam D. Haag, Woodbury, MN (US); David J.W. Aastuen, Shoreview, MN (US); Kevin T. Huseby, Oakdale, MN (US); John D. Le, San Jose, CA (US); Samuel A. Minno, St. Paul, MN (US); Stephen A. Johnson, Woodbury, MN (US); Lin Zhao, Woodbury, MN (US)

(21) Appl. No.: 19/133,789

(22) PCT Filed: Nov. 30, 2023
(86) PCT No.: PCT/IB2023/062074

§ 371 Date: May 29, 2025

Related U.S. Application Data
(60) Provisional application No. 63/386,504, filed on Dec. 8, 2022.

(51) Int. Cl. G02B 5/30; G02B 3/00

(52) U.S. Cl. CPC G02B 5/305; G02B 2003/0093

(57) ABSTRACT

A reflective polarizer includes a plurality of alternating first and second layers substantially reflecting a first polarization state and substantially transmitting a second polarization state, such that for at least a first location, a minimum in a visible wavelength range of an absolute value of a difference in refractive indices of the first and second layers along the second polarization state occurs at a first wavelength of no more than 450 nm. An optical construction includes the reflective polarizer disposed on an optical lens. For a second location of the reflective polarizer on the optical lens, a minimum in the visible wavelength range of an absolute value of a difference in refractive indices of the first and second layers along the second polarization state occurs at a second wavelength at least about 10 nm greater than the first wavelength.

### TECHNICAL FIELD

The present description relates generally to reflective polarizers and optical constructions that include reflective polarizers.

### BACKGROUND

A reflective polarizer can include a plurality of alternating polymeric layers. An optical construction can include a lens and a reflective polarizer disposed on a major surface of the lens.

### SUMMARY

In some aspects, the present description provides a reflective polarizer and an optical construction. The reflective polarizer substantially reflects a first polarization state of substantially normally incident light in a visible wavelength range of about 420 nm to about 680 nm and substantially transmits a second polarization state of the substantially normally incident light. The optical construction includes the reflective polarizer disposed on, and substantially conforming to a curved major surface of an optical lens. The reflective polarizer disposed on the optical lens can be shaped into a predetermined shape so that it substantially conforms to the curved major surface.

The reflective polarizer can have a lower average transmittance (and/or a correspondingly higher average reflectance) for substantially normally incident light having the second polarization state before being shaped into the predetermined shape and a higher average transmittance (and/or a correspondingly lower average reflectance) for at least one location for substantially normally incident light having the second polarization state after being shaped into the predetermined shape. In other words, the reflective polarizer can have a lower (e.g., relatively poor) pass state transmittance (and/or a correspondingly higher pass state reflectance) before being shaped and a lower (e.g., improved) pass state transmittance (and/or a correspondingly higher pass state reflectance) for at least one location after being shaped. After being shaped, the reflective polarizer can have at least one other location (e.g., where there was low strain during shaping of the reflective polarizer) where the pass state transmittance and reflectance did not shift substantially compared to that of the reflective polarizer before being shaped.

In some aspects, the present description provides an optical construction including an optical lens having a curved major surface; and a reflective polarizer disposed on, and substantially conforming to, the curved major surface. The reflective polarizer has first and second total thicknesses at respective first and second locations of the reflective polarizer, where the first total thickness can be at least 5% greater than the second total thickness. The reflective polarizer includes a plurality of alternating first and second layers numbering at least 10 in total, where each of the first and second layers can have an average thickness of less than about 500 nm, such that for substantially normally incident light and for a visible wavelength range of about 420 nm to about 680 nm: for a first polarization state and at each of the first and second locations, the plurality of alternating first and second layers has an average optical reflectance of at least about 50%; and for a second polarization state orthogonal to the first polarization state, the plurality of alternating first and second layers has an average optical reflectance of no more than about 10% for at least the first location. For the second polarization state, an absolute value of a difference in refractive indices of the first and second layers is A. At the first location, a minimum in the visible wavelength range of A occurs at a first wavelength of no more than 450 nm. At the second location, a minimum in the visible wavelength range of A occurs at a second wavelength at least about 10 nm greater than the first wavelength.

In some aspects, the present description provides an optical construction including an optical lens having a curved major surface; and a reflective polarizer disposed on, and substantially conforming to, the curved major surface. The reflective polarizer having first and second total thicknesses at respective first and second locations of the reflective polarizer. The first total thickness is at least 5% greater than the second total thickness. The reflective polarizer includes a plurality of alternating first and second layers numbering at least 10 in total where each of the first and second layers have an average thickness of less than about 500 nm, such that for substantially normally incident light: for a first polarization state and at each of the first and second locations, the plurality of alternating first and second layers has an average optical reflectance in a visible wavelength range of about 420 nm to about 680 nm of at least about 50%; and for a second polarization state orthogonal to the first polarization state, the plurality of alternating first and second layers has an optical reflectance Rp where an average of the optical reflectance Rp in the visible wavelength range can be no more than about 10% for at least the first location. At the first location, a minimum in the visible wavelength range of Rp occurs at a first wavelength of no more than 450 nm. At the second location, a minimum in the visible wavelength range of Rp occurs at a second wavelength at least about 10 nm greater than the first wavelength.

In some aspects, the present description provides an optical construction including an optical lens having a curved major surface; and a reflective polarizer disposed on, and substantially conforming to, the curved major surface. The reflective polarizer has first and second total thicknesses at respective first and second locations of the reflective polarizer. The first total thickness can be at least 5% greater than the second total thickness. The reflective polarizer includes a plurality of polymeric layers numbering at least 10 in total where each layer of the plurality of polymeric layers can have an average thickness of less than about 500 nm, such that for substantially normally incident light, the plurality of polymeric layers has: for a first polarization state and at each of the first and second locations, an average optical reflectance of at least about 60% for a visible wavelength range of about 420 nm to about 680 nm; and for a second polarization state orthogonal to the first polarization state, first and second average optical reflectances Rr and Rb for respective red and UV-blue wavelength ranges. Each of the red and UV-blue wavelength ranges can be at least 20 nm wide. The red wavelength range is disposed between about 600 nm and about 700 nm. The UV-blue wavelength range can be disposed between 380 nm and 450 nm. At the first location, 5%≥Rr≥0.3% and Rb≤Rr/2.5. At the second location, Rb≥Rr.

In some aspects, the present description provides a reflective polarizer including a plurality of alternating first and second layers numbering at least 10 in total where each of the first and second layers can have an average thickness of less than about 500 nm, such that for substantially normally incident light and for a visible wavelength range of about 420 nm to about 680 nm: for a first polarization state: the plurality of alternating first and second layers has an average optical reflectance of at least about 60%; and for a second polarization state orthogonal to the first polarization state: the plurality of alternating first and second layers has an average optical reflectance of no more than about 5%; and a minimum in the visible wavelength range of an absolute value of a difference in refractive indices of the first and second layers occurs at a first wavelength of no more than 450 nm.

In some aspects, the present description provides a reflective polarizer including a plurality of alternating first and second layers numbering at least 10 in total where each of the first and second layers has an average thickness of less than about 500 nm, such that for substantially normally incident light: for a first polarization state: the plurality of alternating first and second layers has an average optical reflectance of at least about 60% in a visible wavelength range of about 420 nm to about 680 nm; for a second polarization state orthogonal to the first polarization state: the plurality of alternating first and second layers has an optical reflectance Rp where an average of the optical reflectance Rp in the visible wavelength range can be no more than about 5%; and a minimum in the visible wavelength range of Rp occurs at a first wavelength of no more than 450 nm.

In some aspects, the present description provides a reflective polarizer including a plurality of polymeric layers numbering at least 10 in total where each layer of the plurality of polymeric layers can have an average thickness of less than about 500 nm, such that for substantially normally incident light, the plurality of polymeric layers has: for a first polarization state, an average optical reflectance of at least about 70% for a visible wavelength range of about 420 nm to about 680 nm; and for a second polarization state orthogonal to the first polarization state, first and second average optical reflectances Rr and Rb for respective red and UV-blue wavelength ranges. Each of the red and UV-blue wavelength ranges can be at least 20 nm wide. The red wavelength range can be disposed between about 600 nm and about 700 nm and the UV-blue wavelength range can be disposed between 380 nm and 450 nm. 5%≥Rr≥0.5% and Rb≤Rr/2.5.

In some aspects, the present description provides a method of making an optical construction. The method includes providing a reflective polarizer and shaping the reflective polarizer into a predetermined shape curved about two orthogonal axes. The reflective polarizer can include a plurality of alternating first and second layers numbering at least 10 in total where each of the first and second layers has an average thickness of less than about 500 nm, such that for substantially normally incident light and a visible wavelength range of about 420 nm to about 680 nm, the reflective polarizer substantially reflects a first polarization state and substantially transmits an orthogonal second polarization state. Providing the reflective polarizer includes selecting the first and second layers so that for substantially normally incident light and for the second polarization state, a minimum in the visible wavelength range of an absolute value of a difference in refractive indices of the first and second layers occurs at a wavelength of no more than 450 nm.

These and other aspects will be apparent from the following detailed description. In no event, however, should this brief summary be construed to limit the claimable subject matter.

### BRIEF DESCRIPTION OF THE DRAWINGS

FIG. 1 is a schematic cross-sectional view of a reflective polarizer, according to some embodiments.

FIGS. 2A-2B are schematic plots of refractive indices versus wavelengths of first and second layers of a reflective polarizer, according to some embodiments.

FIG. 3 is a schematic plot of refractive indices versus wavelength of first and second layers of a reflective polarizer for at least some locations after the reflective polarizer has been shaped, according to some embodiments.

FIG. 4 is a schematic plot of reflectance versus wavelength of reflective polarizer(s) for substantially normally incident light having a (e.g., pass) polarization state, according to some embodiments.

FIGS. 5-6 are schematic cross-sectional views of optical constructions that each include a reflective polarizer disposed on an optical lens, according to some embodiments.

FIG. 7 is a schematic plot of optical reflectance of a plurality of layers versus wavelength for substantially normally incident light for a reflective polarizer or first and second locations of a reflective polarizer for a first (e.g., block) polarization state, according to some embodiments.

FIG. 8 is a schematic plot of optical reflectance of a plurality of layers versus wavelength for substantially normally incident light for a reflective polarizer or first and second locations of a reflective polarizer for a second (e.g., pass) polarization state, according to some embodiments.

FIG. 9 is a schematic plot of the refractive index along the second polarization state for the second layers and for the first layers for the reflective polarizer(s) of FIGS. 7-8, according to some embodiments.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

As is known in the art, multilayer optical films including alternating polymeric layers can be used to provide desired reflection and transmission in desired wavelength ranges and polarization states by suitable selection of layer thicknesses and refractive index differences.

Multilayer optical films and methods of making multilayer optical films are described in U.S. Pat. No. 5,882,774 (Jonza et al.); U.S. Pat. No. 6,783,349 (Neavin et al.); U.S. Pat. No. 6,949,212 (Merrill et al.); U.S. Pat. No. 6,967,778 (Wheatley et al.); and U.S. Pat. No. 9,162,406 (Neavin et al.), for example. A multilayer optical film can be a reflective polarizer substantially reflecting a first polarization state (block state) and substantially transmitting a second polarization state (pass state).

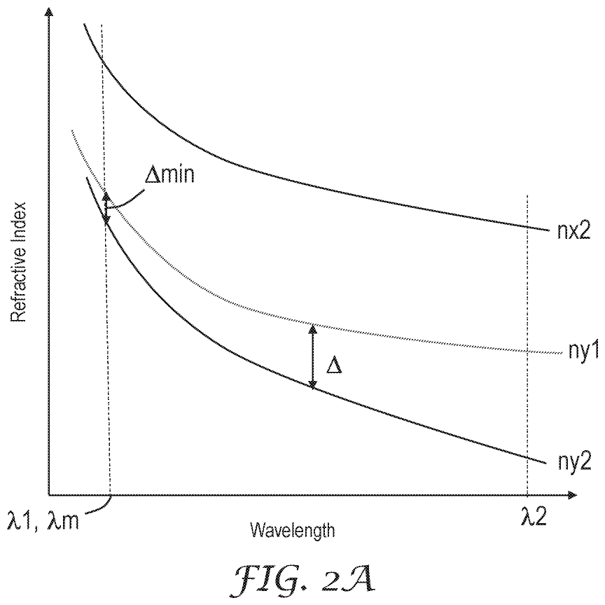

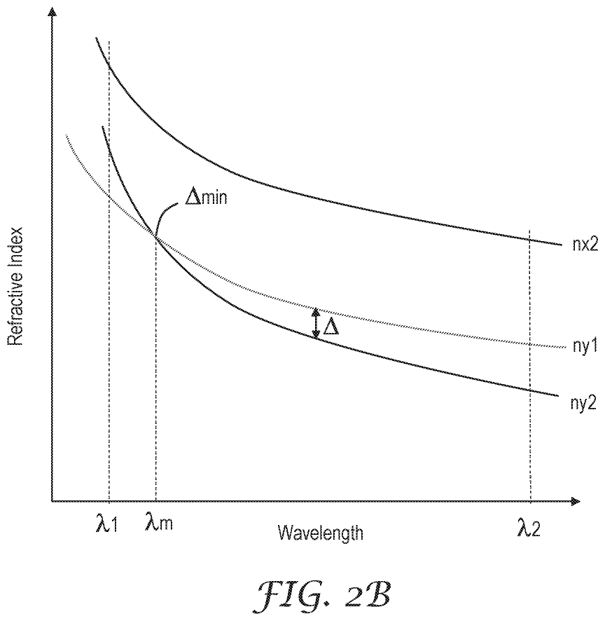

A reflective polarizer can include alternating first and second layers where the first and second layers have substantially different refractive indices for the first polarization state (to provide high reflectance) and approximately matched refractive indices for the second polarization state (to provide low reflectance). Differences in refractive indices of the first and second layers can vary with wavelength due to differences in dispersion of the first and second layers and this can make it difficult to match refractive indices for the second polarization state. To maximize the transmission of visible light for the second polarization state, the first and second layers have typically been chosen to have substantially matched refractive indices near the center of the visible range. However, it has been found, according to some embodiments of the present description, that choosing the layers such that the difference in refractive indices for the second polarization state is a minimum at a lower wavelength (e.g., a wavelength of no more than 450 nm) improves the average transmittance for the second polarization state after the reflective polarizer has been incorporated into an optical construction (e.g., by thermoforming into a curved shape). As describer further elsewhere herein, this can result, for example, when the first layers are substantially optically isotropic, the second layers are birefringent, and shaping (e.g., thermoforming) the film into a desired or predetermined shape results in a relative increase of the refractive index of the second layers relative to the first layers which can result in the wavelength where the refractive indices are matched shifting to higher values due refractive indices generally decreasing with increasing wavelength (see, e.g., FIGS. 2A, 2B and 3). Thus, by selecting the first and second layers such that the refractive indices for the second polarization state are matched at a lower wavelength before shaping (or not matched at any wavelength in a visible wavelength range), the refractive indices can be matched at a higher wavelength after shaping. This can result in lowering the average pass state reflectance, and correspondingly increasing the average pass state transmittance, for at least some location(s) upon forming. Maximizing the average (e.g., over a visible wavelength range of about 420 nm to about 680 nm) pass transmittance can be desired for folded optics applications, for example, such as those described in U.S. Pat. No. 10,678,052 (Ouderkirk et al.), for example.

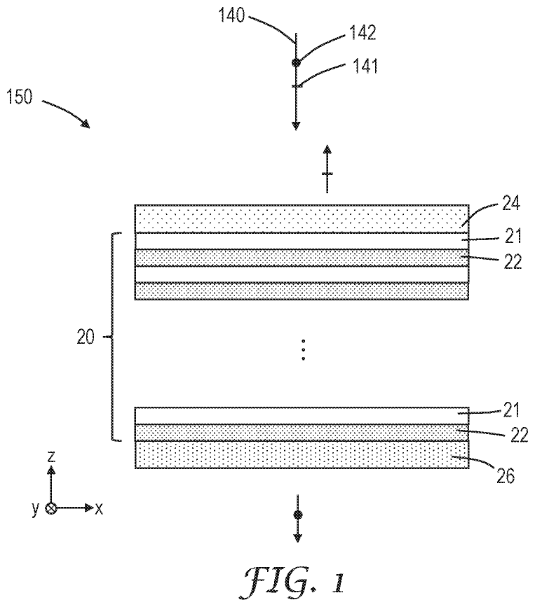

FIG. 1 is a schematic cross-sectional view of a reflective polarizer 150, according to some embodiments. The reflective polarizer 150 includes a plurality 20 of (e.g., polymeric) layers that may be arranged as alternating first and second layers 21 and 22, or that may be arranged in optical repeat units that each include at least two different layers and may optionally include additional layers as described in U.S. Pat. No. 5,103,337 (Schrenk et al.); U.S. Pat. No. 5,540,978 (Schrenk) and U.S. Pat. No. 6,207,260 (Wheatley et al.), for example. In some embodiments, the plurality 20 of layers 21, 22 may number at least 10, 20, 30, 40, 50, 80, 100, 150, or 200 in total. The total number of layers in the plurality of layers 21, 22 can be up to 10000, 5000, 2000, 1000, or 800, for example. Each of the layers in the plurality of layers 21, 22 can have an average thickness less than about 500, 400, 300, 200, or 150 nm, for example. The average thicknesses can be at least about 20, 30, 40, 50, or 60 nm, for example. In some embodiments, the plurality 20 of (e.g., alternating first and second and/or polymeric) layers 21, 22 are disposed between first and second skin layers 24 and 26. In some embodiments, each of the first and second skin layers 24 and 26 has an average thickness of greater than about 400, 500, 600, 700, 800, 900, 1000, 1250, 1500, 1750, or 2000 nm. The average thickness of each of the skin layers can be up to about 150, 100, 50, 30, 20, or 10 microns, for example. As would be appreciated by those of ordinary skill in the art, the reflective polarizer 150 may optionally include other layers (e.g., protective boundary layers) that may each have an average thickness in any of the ranges described for the skin layers 24, 26. Suitable materials for the various layers of the reflective polarizer include polyethylene naphthalate (PEN), polyethylene terephthalate (PET), blends or copolymers thereof (e.g., coPEN 90/10 described in U.S. Pat. No. 6,946,188 (Hebrink et al.), for example), or other polyesters that can become birefringent upon orientation for the higher index (along the block state) layers (e.g., the second layers 22), and polycarbonate, or polyesters, or blends thereof (e.g., an amorphous blend of polycarbonate and glycol-modified PET such as PCTg available from Eastman Chemical Company, Knoxville, TN) that remain substantially isotropic upon orientation for the lower index layers (e.g., the first layers 21) and/or for the skin layers 24 and 26, for example. Other suitable materials are described in the multilayer optical film references provided elsewhere herein.

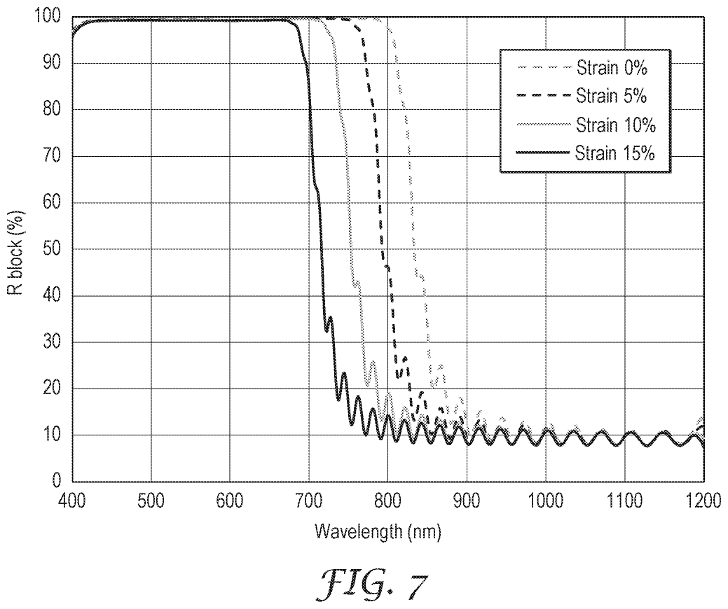

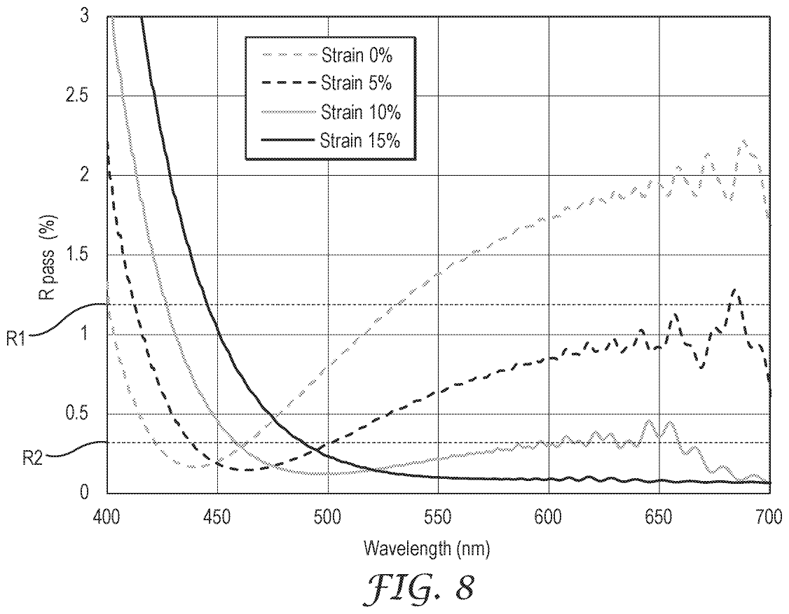

In some embodiments, for substantially normally incident (e.g., within 30, 20, 10, or 5 degrees of normally incident) light 140 and for a visible wavelength range of about 420 nm to about 680 nm, the reflective polarizer 150, or the plurality 20 of layers, substantially reflects (e.g., an average optical reflectance of at least 60, 70, 80, 90, or 95%) a first polarization state 141 and substantially transmits (e.g., an average optical transmittance of at least 60, 70, 80, 85, or 90%) a second polarization state 142. Reflectances for first and second polarization states for a reflective polarizer 150 or a plurality 20 of layers 21, 22 are schematically illustrated in FIGS. 7-8, respectively, for example. Optical absorption is often negligible, so that the transmittance can be, to a good approximation, 100 percent minus the reflectance shown in these figures. The first and second polarization states 141 and 142 of the substantially normally incident light 140 define respective first and second axes (x- and y-axes, respectively, referring to the illustrated x-y-z coordinate system) along which refractive indices may be specified.

FIGS. 2A-2B are schematic plots of refractive indices versus wavelengths of first and second layers 21, 22 of a reflective polarizer, according to some embodiments. The refractive indices ny1 and ny2 are along a pass axis (e.g., y-axis) of the reflective polarizer and are for the respective first and second layers 21 and 22. The refractive index nx2 is along the block axis (e.g., x-axis) and is for the second layers 22. The refractive index of the first layers 21 along the block axis can be the same or about the same as the refractive index ny1 along the pass axis. For example, the first layers 21 can be substantially optically isotropic. Substantially optically isotropic layers can have a maximum birefringence no more than about 0.03, 0.025, 0.02, 0.015, 0.01, or 0.005 for each wavelength in a visible wavelength range of about 420 nm to about 680 nm. The second layers can be birefringent. Birefringent layers can have an in-plane birefringence nx2-ny2 of at least 0.05, 0.06, 0.07, 0.08, 0.09, 0.1, 0.12, 0.14, 0.16, 0.18, or 0.2 for each wavelength in a visible wavelength range of about 420 nm to about 680 nm. The in-plane birefringence nx2-ny2 can be up to about 0.4, 0.35, 0.3, or 0.25 for each wavelength in the visible wavelength range, for example. The refractive indices of FIGS. 2A-2B can correspond to reflective polarizers before being formed into a desired or predetermined (e.g., curved) shape.

FIG. 3 is a schematic plot of refractive indices versus wavelength of first and second layers 21, 22 of a reflective polarizer, according to some embodiments, and can correspond to at least some locations on the same reflective polarizer as that of FIG. 2A or 2B after it has been shaped into the desired shape. For example, the wavelength λm where |ny1-ny2| is a minimum in the visible wavelength range may shift to λm′ after shaping for at least some location(s) on the reflective polarizer. A greater strain may be applied to the reflective polarizer of FIG. 2A than to the reflective polarizer of FIG. 2B during shaping to arrive at the reflective polarizer of FIG. 3.

As used herein, a “minimum” in a specified wavelength range of a quantity that is a function of wavelength is the smallest value of the quantity in the specified wavelength range. In other words, there is no other wavelength in the specified range where the quantity has a smaller value, though the quantity might have a smaller value outside the specified range. If a quantity has more than one different local minima in the specified wavelength range, only the smallest of these local minima may be identified as the “minimum”. The “minimum” in the specified wavelength range of the quantity may occur at a boundary of the specified wavelength range. The “minimum” in the specified wavelength range of the quantity may be described as the smallest value in the specified wavelength range of the quantity.

A wavelength range of λ1 to λ2 is schematically illustrated in FIGS. 2A, 2B, and 3. The wavelength λ1 may be about 360 nm, about 380 nm, about 400 nm, about 420 nm, or about 450 nm, for example. The wavelength λ2 may be about 700 nm, about 680 nm, about 650 nm, or about 600 nm, for example. The wavelength range of λ1 to λ2 may be from about 380 nm to about 700 nm or from about 420 nm to about 680 nm, for example.

The wavelength where the curves for ny1 and ny2 cross before (e.g., thermo-) forming can be selected, for example, by choosing the materials for the first and second layers and/or by adjusting the stretching conditions. The material for the first layers (layers with lower index along the block axis), for example, can be a polycarbonate, an amorphous (co)polyester, other suitable substantially isotropic polymers, or a blend thereof, blended with a naphthalene dicarboxylate (NDC) containing polymer to increase the refractive index. Increasing the NDC component in such a blend can increase the refractive index of the first layers shifting the curve for ny1 up (relative to the conventional case where the indices cross at roughly 550 nm) and resulting in a decrease in the wavelength where the ny1 curve crosses the ny2 curve, and/or where the pass state reflectance is a minimum, if no compensating changes are made to the material of the second layers. Alternatively, or in addition, the index n2y of the second layers can be decreased to shift the cross over wavelength. This can be done via material choice and/or processing conditions. For example, reducing the stretching along the machine direction so that the stretching is closer to truly uniaxial can reduce n2y. As another example, the second layers can be a polyethylene naphthalate (PEN) or a PEN copolymer (e.g., coPEN 90/10) blended with a lower index material to lower the index of the layers compared to layers of PEN or the PEN copolymer, or the second layers can be a copolyester that becomes birefringent upon orientation but has copolymer units that result in a lower index than PEN or coPEN 90/10, for example. Process changes can be combined with material changes where needed to sufficiently reduce n2y. In some embodiments, the refractive index curves cross outside of the visible range or do not cross at all (see, e.g., FIG. 2A).

In some embodiments, a reflective polarizer 150 includes a plurality 20 of alternating first and second layers 21, 22 numbering at least 10 in total (or in a range described elsewhere herein), where each of the first and second layers 21, 22 has an average thickness of less than about 500 nm (or in a range described elsewhere herein), such that for substantially normally incident light 140 (see, e.g., FIG. 1) and for a visible wavelength range of about 420 nm to about 680 nm (e.g., corresponding to the wavelength range λ1 to λ2 schematically illustrated in FIGS. 2A, 2B and 3): for a first polarization state 141 (e.g., polarized along x-axis), the plurality of alternating first and second layers has an average optical reflectance of at least 60% (see, e.g., FIG. 7); and for a second polarization state 142 (e.g., polarized along y-axis) orthogonal to the first polarization state: the plurality of alternating first and second layers 21, 22 has an average optical reflectance of no more than about 5% (see, e.g., FIG. 8); and a minimum Δmin (see, e.g., FIGS. 2A-2B) in the visible wavelength range (e.g., λ1 to λ2) of an absolute value of a difference in refractive indices of the first and second layers (ny1 and ny2) occurs at a first wavelength Δm of no more than 450, 445, 440, 435, 430, 425, or 420 nm. The minimum Δmin can be zero as schematically illustrated in FIG. 2B or greater than zero as schematically illustrated in FIG. 2A. Generally, if the curve for the refractive indices ny1 and ny2 cross or intersect for a wavelength in the visible wavelength range, the minimum will be zero; otherwise, the minimum will be greater than zero. In some embodiments, for substantially normally incident light and the second polarization state, the refractive index ny1 of the first layer 21 is less than the refractive index ny2 of the second layer 22 for at least one wavelength in the visible wavelength range that is less than the first wavelength λm and the refractive index ny1 of the first layer 21 is greater than the refractive index of the second layer ny2 for at least one wavelength in the visible wavelength range that is greater than the first wavelength λm. In some embodiments, for substantially normally incident light 140 and the second polarization state 142, the refractive index ny1 of the first layer is greater than the refractive index ny2 of the second layer for each wavelength in the visible wavelength range. In some embodiments, the minimum λmin is greater than zero, 0.001, 0.002, 0.003, 0.004, 0.005, or 0.006. In some embodiments, for substantially normally incident light 140 and the second polarization state 142, the refractive index ny1 of the first layer is greater than the refractive index ny2 of the second layer by at least about 0.001, 0.002, 0.003, 0.004, 0.005, 0.006 for each wavelength in the visible wavelength range. In some embodiments, for substantially normally incident light 140 and the second polarization state 142, the refractive index ny1 of the first layer is greater than the refractive index ny2 of the second layer by at least 0.005, 0.0055, 0.006, 0.0065, or 0.007 at a wavelength of about 550 nm.

In some embodiments, for substantially normally incident light 140, a refractive index (e.g., nx1 which may equal or about equal to ny1) of the first layer 21 along the first polarization state 141 is less than a refractive index nx2 of the second layer 22 along the first polarization state 141 by at least about 0.05, 0.06, 0.07, 0.08, 0.09, 0.1, 0.12, 0.14, 0.16, 0.18, or 0.2 for each wavelength in the visible wavelength range. In some embodiments, nx2-nx1 or nx2-ny2 is up to about 0.4, 0.35, or 0.3, for example.

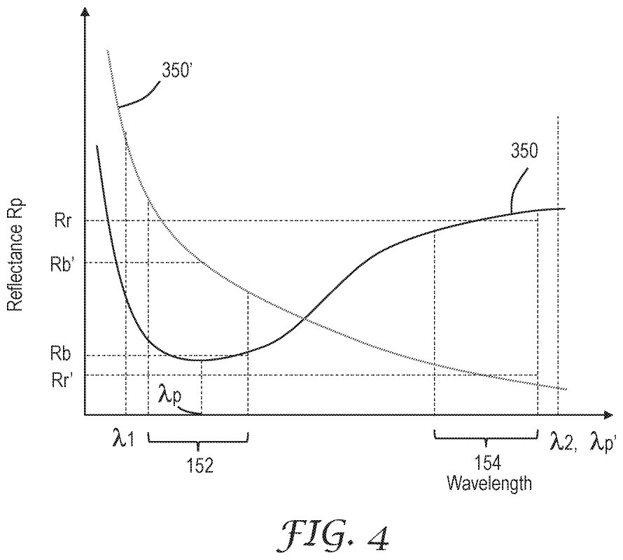

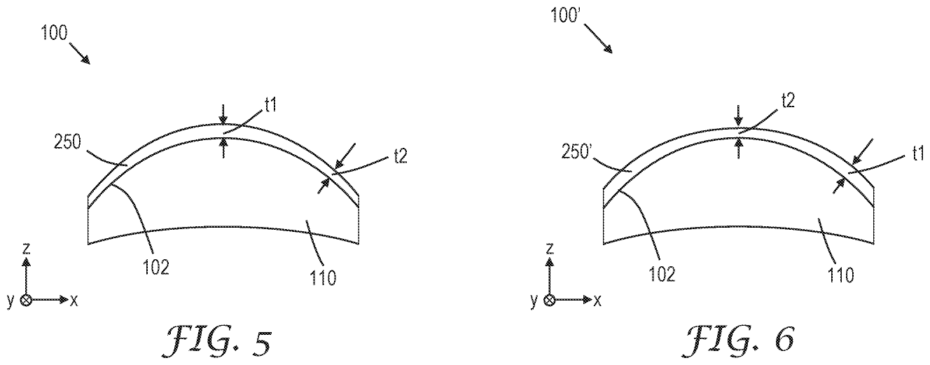

In some embodiments, for substantially normally incident light 140 (see, e.g., FIG. 1), for a visible wavelength range of about 420 nm to about 680 nm and for the first polarization state 141, the plurality 20 of (e.g., alternating first and second and/or polymeric) layers has an average optical reflectance of at least about 50, 60, 70, 80, 90, or 95%. In some embodiments, for substantially normally incident light 140, for the visible wavelength range of about 420 nm to about 680 nm and for the second polarization state 142, the plurality 20 of layers has an average optical reflectance of no more than about 10, 7, 5, 4, 3, 2, or 1.5%. In some embodiments, this average optical reflectance for the second polarization state is at least about 0.3, 0.4, 0.5, 0.55, 0.6, 0.65, 0.7, 0.8, 0.9, 1, or 1.1%. In some embodiments, the average optical reflectance for the second polarization state is higher before the reflective polarizer is formed into a predetermined shape curved about two orthogonal axes and lower for at least one location (e.g., second location having thickness t2 in FIGS. 5-6) after the reflective polarizer is formed into the predetermined shape (e.g., due to the shift in the wavelength λm). In some embodiments, after the reflective polarizer is formed into the predetermined shape, the average optical reflectance for the second polarization state is higher at a first location (e.g., location having thickness t1 in FIGS. 5-6) and lower at a second location (location having thickness t2 in FIGS. 5-6).

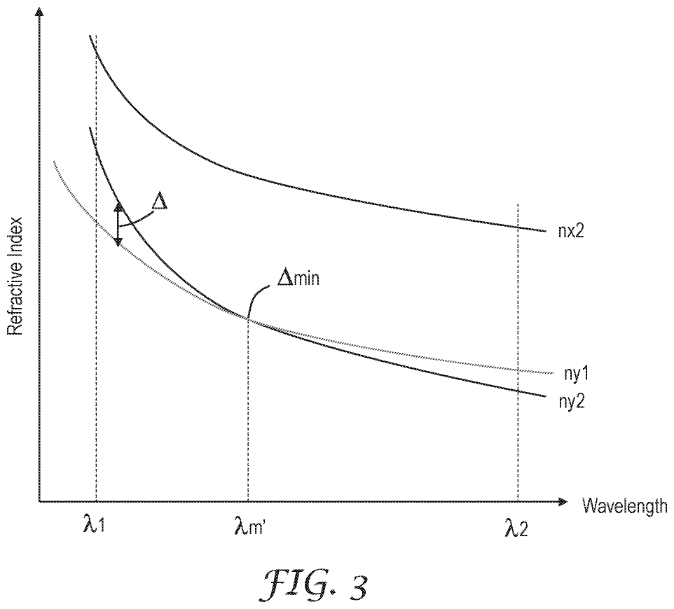

FIG. 4 is a schematic plot of reflectance versus wavelength of reflective polarizer(s), for substantially normally incident light having a second (e.g., pass) polarization state 141, according to some embodiments. Optical reflectance 350 can correspond to an optical reflectance of reflective polarizer 150 before being formed into a predetermined shape or to a first location (e.g., a location experiencing low strain during forming) of the reflective polarizer 150 after being shaped (e.g., into a predetermined shape curved about two orthogonal axes). Optical reflectance 350′ can correspond to an optical reflectance of a comparative reflective polarizer before being formed into a predetermined shape or to a second location (e.g., a location experiencing high strain during forming) of the reflective polarizer 150 after being shaped. The optical reflectances 350, 350′ can be immersed reflectances corresponding to reflectances of a plurality 20 of layers 21, 22. The first and second locations are different location of the reflective polarizer and can be spaced apart by at least about 10, 20, or 30 percent of a largest dimension of the reflective polarizer, for example. The optical reflectance 350 comprises average optical reflectances Rb and Rr in respective UV-blue and red wavelength ranges 152 and 154. A UV-blue wavelength range can include ultraviolet (UV) and/or visible wavelengths. The optical reflectance 350′ comprises average optical reflectances Rb′ and Rr′ in the respective UV-blue and red wavelength ranges 152 and 154. The UV-blue wavelength range 152 can be disposed between about 380 nm and about 450 nm, or about 390 nm and about 445 nm, or about 400 nm and about 440 nm, for example. The red wavelength range 154 can be disposed between about 600 nm and about 700 nm, or about 620 nm and about 680 nm, for example. The UV-blue wavelength range 152 and the red wavelength range 154 can each independently be at least about 20, 25, 30, 35, 40, 45, or 50 nm wide, for example. Each of the wavelength ranges described herein should be understood to be continuous wavelength ranges, unless indicated differently.

In some embodiments, a reflective polarizer 150 includes a plurality 20 of polymeric layers 21, 22 numbering at least 10 in total (or in a range described elsewhere herein), where each layer of the plurality 20 of polymeric layers 21, 22 has an average thickness of less than about 500 nm (or in a range described elsewhere herein), such that for substantially normally incident light 140, the plurality of polymeric layers has: for a first polarization state 141, an average optical reflectance of at least about 70, 75, 80, 85, 90, or 95% for a visible wavelength range of about 420 nm to about 680 nm; and for a second polarization state 142 orthogonal to the first polarization state, first and second average optical reflectances Rr and Rb for respective red (154) and UV-blue (152) wavelength ranges. Each of the red and UV-blue wavelength ranges 154, 152 is at least 20 nm wide. The red wavelength range 154 can be disposed between about 600 nm and about 700 nm. The UV-blue wavelength range 152 can be disposed between 380 nm and 450, 445, 440, 435, 430, 425, or 420 nm. In some embodiments, 5%≥Rr≥0.5%, and Rb≤Rr/2.5. In some such embodiments, or in other embodiments, Rb≤Rr/3, or Rb≤Rr/3.5, or Rb≤Rr/4, or Rb≤Rr/4.5, or Rb≤Rr/5, or Rb≤Rr/5.5, or Rb≤Rr/6, or Rb≤Rr/6.5, or Rb≤Rr/7, or Rb≤Rr/7.5, or Rb≤Rr/8, or Rb≤Rr/8.5, or Rb≤Rr/9, or Rb≤Rr/9.5, or Rb≤Rr/10, or Rb≤Rr/10.5, or Rb≤Rr/11. For example, for the “Strain 0” curve in FIG. 8 which is a plot of optical reflectance versus wavelength for substantially normally incident light and the second polarization state 142, Rb for a wavelength rang of 430 nm to 450 nm is about 0.18% and Rr for a wavelength range of 675 nm to 695 nm is about 2.04% so that Rr/Rb is about 11.3. In some such embodiments, or in other embodiments, Rr-Rb ≥0.5, 0.6, 0.7, 0.8, 0.9, 1, 1.1, 1.2, 1.3, 1.4, 1.5, 1.6, 1.7, or 1.8%. In some such embodiments, or in other embodiments, for substantially normally incident light 140 and the second polarization state 142, an optical reflectance of the plurality of polymeric layers has a minimum in the UV-blue wavelength range (see, e.g., FIGS. 4 and 8). The plurality of polymeric layers 21, 22 may be disposed between first and second skin layers 24 and 26 which may each have a thickness that is greater than about 500 nm or in a range described elsewhere herein.

In some embodiments, for the second polarization state 142, the plurality 20 of alternating first and second layers has an optical reflectance Rp. In some embodiments, a minimum in the visible wavelength range of Rp occurs at a first wavelength λp (see, e.g., FIG. 4) of no more than 450, 445, 440, 435, 430, 425, or 420 nm. The minimum may alternatively be specified for a different wavelength range (e.g., 380 nm to 600 mm or to 550 nm) or another minimum may be specified for a different wavelength range. In some embodiments, the optical reflectance Rp has a minimum in a wavelength range of 380 nm to 600 nm or to 550 nm at a wavelength of no more than 420 nm. In some embodiments, the optical reflectance Rp has a minimum in a wavelength range of 380 nm to 600 nm at a wavelength of no more than 420, 410, 400, 390, or 380 nm.

FIGS. 5-6 are schematic cross-sectional views of optical constructions 100, 100′ including a reflective polarizer 250, 250′ disposed on a curved major surface 102 of an optical lens 110, according to some embodiments. The optical lens 102 can be biconvex, plano-convex, positive meniscus, negative meniscus, plano-concave, or biconcave, for example. The optical lens 102 can comprise a polymer and may be insertion injection molded onto the reflective polarizer 250, 250′ as generally described in U.S. Pat. Appl. Pub. No. 2021/0208320 (Ambur et al.), for example. The optical lens 102 can be a monolithic lens (simple lens) or can be a compound lens that includes a monolithic portion that is injection molded onto the reflective polarizer, for example. The reflective polarizer 250, 250′ can correspond to the reflective polarizer 150 after it has been shaped. The shaped reflective polarizer 250, 250′ can have a predetermined shaped curved about two orthogonal axes (e.g., x- and y-axes). The reflective polarizer 250, 250′ has first and second total thickness t1 and t2 at respective first and second locations. The reflective polarizer 250 may be thermoformed into the curved shape using positive forming which results in minimum strain (and maximum thickness since the thickness can be unchanged or substantially unchanged in the minimum strain location(s)) near a center of the curved major surface 102. The reflective polarizer 250′ may be thermoformed into the curved shape using negative forming which results in maximum strain (and minimum thickness) near a center of the curved major surface 102. Positive and negative forming are generally described in U.S. Pat. Appl. Pub. No. 2020/0241187 (Jennings et al.), for example. The first location (with total thickness t1) of the reflective polarizer 250, 250′ can have any of the reflection/transmission properties described for the reflective polarizer 150, while the second location (with total thickness t2) of the reflective polarizer 250, 250′ can have reflectance and/or refractive indices shifted as described further elsewhere herein.

In some embodiments, an optical construction 100, 100′ includes an optical lens 110 having a curved major surface 102 and a reflective polarizer 250, 250′ disposed on, and substantially conforming (e.g., conforming, or nominally conforming, or conforming up to variations less than about 20, 10, or 5 percent of an average total thickness of the reflective polarizer) to, the curved major surface 102. The reflective polarizer 250, 250′ has first and second total thicknesses t1 and t2 at respective first and second locations (locations schematically indicated by the t1 and t2 labels) of the reflective polarizer 250, 250′. The first total thickness t1 can be at least 5% greater than the second total thickness t2. The reflective polarizer 250, 250′ includes a plurality of alternating first and second layers 21, 22 numbering at least 10 in total (or in another range described elsewhere herein), where each of the first and second layers 21, 22 has an average thickness of less than about 500 nm (or in another range described elsewhere herein), such that for substantially normally incident light 140 and for a visible wavelength range of about 420 nm to about 680 nm: for a first polarization state 141 and at each of the first and second locations, the plurality of alternating first and second layers has an average optical reflectance of at least about 50, 55, 60, 65, 70, 75, 80, 85, 90, or 95%; and for a second polarization state 142 orthogonal to the first polarization state, the plurality of alternating first and second layers has an average optical reflectance of no more than about 10% for at least the first location, an absolute value of a difference in refractive indices of the first and second layers being Δ, where: at the first location, a minimum in the visible wavelength range of Δ occurs at a first wavelength λm of no more than 450 nm; and at the second location, a minimum in the visible wavelength range of Δ occurs at a second wavelength λm′ at least about 10 nm greater than the first wavelength λm. The first wavelength λm may be no more than 445, 440, 435, 430, 425, or 420 nm. The second wavelength λm′ may be at least about 20, 30, 40, 50, 60, 70, 80, 90, 100, 110, 120, 130, 140 or 150 nm greater than the first wavelength λm. In some embodiments, the first wavelength λm is no more 440, 435, 430, 425, or 420 nm and the second wavelength λm′ is in a range of about 450 nm to about 600 nm. The second wavelength λm′ can be in a range of about 440, 450, 460 or 470 nm to about 600, 590, 580, 570, 560, 550, or 540 nm, for example.

In some embodiments, for the second polarization state 142, the plurality 20 of alternating first and second layers has an optical reflectance Rp. In some embodiments, at the first location, a minimum in the visible wavelength range of Rp occurs at a first wavelength λp (see, e.g., FIG. 4) of no more than 450 nm; and at the second location, a minimum in the visible wavelength range of Rp occurs at a second wavelength λp′ at least about 10 nm greater than the first wavelength λp.

The first wavelength λp can be no more than 445, 440, 435, 430, 425, or 420 nm. The second wavelength λp′ can be at least about 20, 30, 40, 50, 60, 70, 80, 90, 100, 110, 120, 130, 140, or 150 nm greater than the first wavelength. The minimum at the first and second locations may alternatively be specified for a different wavelength range (e.g., 380 nm to 600 mm or to 550 nm) or another minimum may be specified for a different wavelength range. In some embodiments, at the first location, the optical reflectance Rp has a minimum in a first wavelength range of 380 nm to 600 nm or to 550 nm at a first wavelength of no more than 420 nm; and at the second location, the optical reflectance Rp has a minimum in the first wavelength range at a second wavelength at least 20 nm greater than the first wavelength. In some embodiments, at the first location, the optical reflectance Rp has a minimum in a wavelength range of 380 nm to 600 nm at a wavelength of no more than 420, 410, 400, 390, or 380 nm. The first and second wavelengths λp and λp′ can be equal to or about equal to the first and second wavelengths λm and λm′.

The first location of the reflective polarizer 250, 250′ (where the total thickness of the reflective polarizer is t1) can have any of the optical properties described for reflective polarizer 150. For example, in some embodiments, for substantially normally incident light 140, for the second polarization state 142, and for the first location, the refractive index ny1 of the first layer 21 is less than the refractive index ny2 of the second layer 22 for at least one wavelength in the visible wavelength range that is less than the first wavelength λm and the refractive index ny1 of the first layer 21 is greater than the refractive index ny2 of the second layer 22 for at least one wavelength in the visible wavelength range that is greater than the first wavelength λm (e.g., Δmin can be zero). In some embodiments, for substantially normally incident light 140, for the second polarization state 142, and for the first location, the refractive index ny1 of the first layer 21 is greater than the refractive index ny2 of the second layer 22 for each wavelength in the visible wavelength range. In some embodiments, for substantially normally incident light 140, for the second polarization state 142, and for the first location, the refractive index ny1 of the first layer 21 is greater than the refractive index ny2 of the second layer 22 by at least about 0.001, 0.002, 0.003, 0.004, 0.005, or 0.006 for each wavelength in the visible wavelength range. In some embodiments, for the first location and for substantially normally incident light 140, a refractive index (e.g., equal, or about equal to ny1) of the first layer 21 along the first polarization state 141 is less than a refractive index nx2 of the second layer 22 along the first polarization state 141 by at least about 0.05, 0.06, 0.07, 0.08, 0.09, 0.1, 0.12, 0.14, 0.16, 0.18, 0.2 for each wavelength in the visible wavelength range.

In some embodiments, an optical construction 100, 100′ includes an optical lens 110 having a curved major surface 102 and a reflective polarizer 250, 250′ disposed on, and substantially conforming to, the curved major surface 102. The reflective polarizer 250, 250′ has first and second total thicknesses t1 and t2 at respective first and second locations of the reflective polarizer. The first total thickness t1 can be at least 5% greater than the second total thickness t2. The reflective polarizer 250, 250′ includes a plurality 20 of polymeric layers 21, 22 numbering at least 10 in total, where each layer of the plurality 20 of polymeric layers has an average thickness of less than about 500 nm, such that for substantially normally incident light 140, the plurality 20 of polymeric layers has: for a first polarization state 141 and at each of the first and second locations, an average optical reflectance of at least about 60, 65, 70, 75, 80, 85, 90, or 95% for a visible wavelength range of about 420 nm to about 680 nm; and for a second polarization state 142 orthogonal to the first polarization state, first and second average optical reflectances Rr and Rb for respective red and UV-blue wavelength ranges 154 and 152 (see, e.g., FIGS. 4 and 8). Each of the red and UV-blue wavelength ranges is at least 20 nm wide. The red wavelength range 154 is disposed between about 600 nm and about 700 nm. The UV-blue wavelength range is disposed between 380 nm and 450, 445, 440, 435, 430, 425, or 420 nm. Rr and Rb at the first location can correspond to the Rr and Rb schematically depicted in FIG. 4, while Rr and Rb at the second location can correspond to the Rr′ and Rb′ schematically depicted in FIG. 4, for example. In some embodiments, at the first location, 5%≥Rr≥0.3% and Rb≤Rr/2.5; and at the second location, Rb≥Rr. In some such embodiments, or in other embodiments, at the first location, Rb≤Rr/3, or Rb≤Rr/3.5, or Rb≤Rr/4, or Rb≤Rr/4.5, or Rb≤Rr/5, or Rb≤Rr/5.5, or Rb≤Rr/6, or Rb≤Rr/6.5, or Rb≤Rr/7, or Rb≤Rr/7.5, or Rb≤Rr/8, or Rb≤Rr/8.5, or Rb≤Rr/9, or Rb≤Rr/9.5, or Rb≤Rr/10, or Rb≤Rr/10.5, or Rb≤Rr/11. In some such embodiments, or in other embodiments, at the second location, Rb≥1.2 Rr, or Rb≥1.5 Rr, or Rb≥2 Rr, or Rb≥3 Rr, or Rb≥4 Rr, or Rb ≥6 Rr, Rb≥8 Rr. In some such embodiments, or in other embodiments, at the first location, Rr-Rb≥0.5, 0.6, 0.7, 0.8, 0.9, 1, 1.1, 1.2, 1.3, 1.4, 1.5, 1.6, 1.7, or 1.8%. In some such embodiments, or in other embodiments, at the second location Rb-Rr≥0.4, 0.5, 0.6, 0.7, 0.8, 0.9, 1, 1.1, 1.2, or 1.3%. For example, in some embodiments, at the first location, Rr-Rb≥0.5%; and at the second location Rb-Rr≥0.4%. In some embodiments, Rb at the second location is at least about 0.5, 0.6, 0.7, 0.8, 0.9, 1, or 1.1% greater than Rb at the first location (e.g., Rb′-Rb at least about 0.5%). In some such embodiments, or in other embodiments, Rr at the second location is at least about 0.4, 0.5, 0.6, 0.7, 0.8, 0.9, 1, 1.1, 1.2, 1.3, 1.4, 1.5, 1.6, 1.7, 1.8% less than Rr at the first location (e.g., Rr-Rr′ at least about 0.4%). In some such embodiments, or in other embodiments, for substantially normally incident light 140, the second polarization state 142 and the first location, an optical reflectance of the plurality of polymeric layers has a minima in the UV-blue wavelength range (see, e.g., FIGS. 4 and 8).

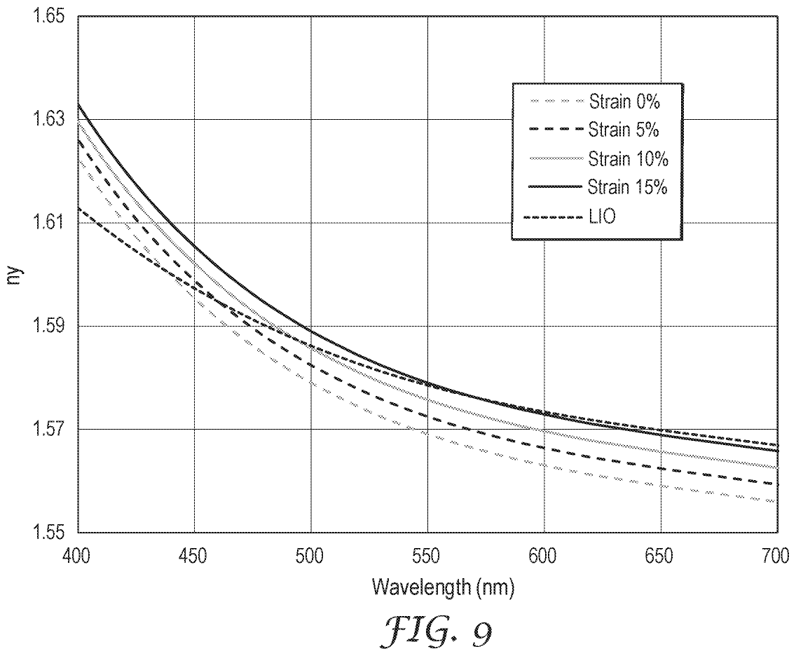

FIGS. 7-8 are plots of optical reflectance of a reflective polarizer 150 or a plurality 20 of layers 21, 22 versus wavelength for substantially normally incident light for a reflective polarizer 150 (“Strain 0%”) or a first location (“Strain 0%”) and second location(s) (any of “Strain 5%”, “Strain 10%”, or “Strain 15%”) of a reflective polarizer 250, 250′ for first and second polarizations states 141 and 142, respectively. FIG. 9 is a plot of the refractive index along the second polarization state 142 (y-axis) for the second layers 22 and for the first layers 21 (“LIO” or low index optical layers) for the reflective polarizer(s) of FIGS. 7-8, according to some embodiments. The plots of FIGS. 7-9 were obtained as follows. Samples of a reflective polarizer film available from 3M Company (St. Paul, MN) under the tradename IQP-E were thermoformed into curved shapes using positive forming (minimal strain near center-see, e.g., FIG. 5) and using negative forming (maximum strain near center-see, e.g., FIG. 6) as generally described in U.S. Pat. Appl. Pub. No. 2020/0241187 (Jennings et al.). Samples formed with positive forming had maximum strains of about 5% or 15% and a sample formed via negative forming had a maximum strain of about 10%. Optical reflectance before and after forming the samples was determined and optical modeling was used to determine the refractive indices of the high index optical (HIO) layers and the LIO layers before and after forming. The reflectance determined from the optical modeling was in good agreement with the experimental data. The reflectance was determined as the immersed reflectance of the reflective polarizer disposed between glass layers having an index of 1.51. The immersed reflectance of the reflective polarizer corresponds to a good approximation to the reflectance of the plurality 20 of layers 21, 22. In order to model a film having a different wavelength where the refractive indices along the second polarization state 142 for the HIO and LIO layers cross, the index of the LIO layers was increased in the model by constant percentage to result in the LIO curve shown in FIG. 9. This change in the refractive index of the LIO layers in the model can correspond to blending a higher index polymer with the original LIO material, for example, to increase the refractive index of the resulting LIO material. The optical reflectance for the first and second polarization states 141 and 142 before and after thermoforming was then determined via optical modeling using the refractive indices determined before and after thermoforming for the IQE-Q reflective polarizer for the HIO layers and using the refractive index of the (isotropic) LIO layers (the same before and after thermoforming) given by the LIO curve of FIG. 9. The resulting reflectances are shown in FIGS. 7-8.

In some embodiments, for substantially normally incident light 140, for the visible wavelength range of about 420 nm to about 680 nm, and for the second polarization state 142, the plurality 20 of (e.g., alternating first and second and/or polymeric) layers has first and second average optical reflectances at the respective first and second locations, where the second average optical reflectance is less than the first average optical reflectance. In some embodiments, the second average optical reflectance is less than the first average optical reflectance by at least about 0.1, 0.15, 0.2, 0.25, 0.3, 0.35, 0.4, 0.45, 0.5, 0.55, 0.6, 0.65, 0.7, 0.75, or 0.8%. For example, in FIG. 8, the average optical reflectance is about 1.21% at 0% strain (denoted R1 in FIG. 8), about 0.61% at 5% strain, about 0.33% at 10% strain, and about 0.37% at 15% strain (denoted R2 in FIG. 8). In the example of 15% strain at the second location and 0% strain at the first location, the second average optical reflectance is less than the first average optical reflectance by about 0.84% (R1-R2). The 0% strain condition can correspond to a first location on the reflective polarizer and the 5, 10, or 15% strain conditions can correspond to a second location on the reflective polarizer. In some embodiments, a reflective polarizer suitable for use when a greater strain condition is needed has a first optical reflectance higher than that of the 0% strain condition of FIG. 8 and/or can have a minima in the UV-blue wavelength range shifted to lower wavelengths than the 0% strain condition of FIG. 8.

The reflective polarizer 150, 250, 250′ can have a band edge in a near-infrared range (see, e.g., FIG. 7). In some embodiments, for the reflective polarizer 150, and/or for at least the first location of the reflective polarizer 250, 250′, for substantially normally incident light 140 and the first polarization state 141, the plurality 20 of alternating first and second layers has an optical reflectance versus wavelength comprising a band edge along which the optical reflectance generally decreases from greater than about 80% percent to less than about 20% with increasing wavelength, where the band edge comprises a band edge wavelength where the optical reflectance is about 50%, and where the band edge wavelength is at least about 650 nm and no more than about 1000 nm. The band edge wavelength may be at least about 680, 690, or 700 nm, for example. The band edge wavelength may be no more than about 950, 900, or 850 nm, for example. In some embodiments, a method of making an optical construction is provided. The method can include providing a reflective polarizer 150 and shaping the reflective polarizer 150 into a predetermined shape curved about two orthogonal axes (e.g., so that the shaped reflective polarizer corresponds to reflective polarizer 250 or 250′). In some embodiments, the method includes, after shaping the reflective polarizer into the predetermined shape, molding an optical lens 110 onto the reflective polarizer. For example, the reflective polarizer can be shaped into the predetermined shape using the methods of U.S. Pat. Appl. Pub. No. 2020/0241187 (Jennings et al.), for example, and then an optical lens 110 can be insert injection molded onto the reflective polarizer as described in U.S. Pat. Appl. Pub. No. 2021/0208320 (Ambur et al.), for example. In some embodiments, shaping the reflective polarizer into a predetermined shape comprises molding an optical lens 110 onto the reflective polarizer. For example, instead of thermoforming the reflective polarizer into the predetermined shape prior to injection molding, the optical lens 110 can be injection molded onto the reflective polarizer 150 (while being flat or only part way formed into the final shape) resulting in the reflective polarizer 150 being formed into the predetermined shape during the molding process.

The provided reflective polarizer 150 can be as described elsewhere herein. For example, the reflective polarizer 150 can include a plurality of alternating first and second layers 21, 22 numbering at least 10 in total (or in a range described elsewhere herein), where each of the first and second layers 21, 21 has an average thickness of less than about 500 nm (or in a range described elsewhere herein), such that for substantially normally incident light 140 and a visible wavelength range of about 420 nm to about 680 nm, the reflective polarizer 150 substantially reflects (e.g., an average optical reflectance of at least 60% or in a range described elsewhere herein) a first polarization state 141 and substantially transmits (e.g., an average optical transmittance of at least 60% or in a range described elsewhere herein) an orthogonal second polarization state 142. Providing the reflective polarizer 150 can comprise selecting the first and second layers 21 and 22 so that for substantially normally incident light 140 and for the second polarization state 142, a minimum in the visible wavelength range of an absolute value of a difference in refractive indices of the first and second layers occurs at a first wavelength of no more than 450, 445, 440, 435, 430, 425, or 420 nm.

In some embodiments, after shaping the reflective polarizer into the predetermined shape, the reflective polarizer can be as described for reflective polarizer 250, 250′. For example, in some embodiments, after shaping the reflective polarizer into the predetermined shape, the reflective polarizer has first and second total thicknesses t1 and t2 at respective first and second locations of the reflective polarizer, where the first total thickness t1 is at least 5% greater than the second total thickness t2, such that for substantially normally incident light 140 and the visible wavelength range: for the first polarization state 140 and at each of the first and second locations, the plurality of alternating first and second layers 21, 22 has an average optical reflectance of at least about 60%; and for the second polarization state 142, the plurality of alternating first and second layers 21, 22 has an average optical reflectance of no more than about 5% for at least the first location.

In some embodiments, after shaping the reflective polarizer into the predetermined shape, for at least one location (e.g., a location having a total thickness t2) of the reflective polarizer and for substantially normally incident light 140, a minimum in the visible wavelength range of an absolute value of a difference in refractive indices of the first and second layers along the second polarization state occurs at a second wavelength in a range of about 450 nm to about 600 nm or in a range described elsewhere herein. The first wavelength can be no more than 440 nm or can be in a range described elsewhere herein. The second wavelength can be greater than the first wavelengths by at least about 20 nm or by an amount in a range described elsewhere herein.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 5 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.95 and 1.05, and that the value could be 1.

Terms such as “substantially” will be understood in the context in which they are used and described in the present description by one of ordinary skill in the art. If the use of “substantially” with reference to a property or characteristic is not otherwise clear to one of ordinary skill in the art in the context in which it is used and described in the present description and when it would be clear to one of ordinary skill in the art what is meant by an opposite of that property or characteristic, the term “substantially” will be understood to mean that the property or characteristic is exhibited to a greater extent than the opposite of that property or characteristic is exhibited.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations, or variations, or combinations of the specific embodiments discussed herein. Therefore, it is intended that this disclosure be limited only by the claims and the equivalents thereof.

1-15. (canceled)

16. An optical construction comprising:
an optical lens having a curved major surface; and
a reflective polarizer disposed on, and substantially conforming to, the curved major surface, the reflective polarizer having first and second total thicknesses at respective first and second locations of the reflective polarizer, the first total thickness at least 5% greater than the second total thickness, the reflective polarizer comprising a plurality of alternating first and second layers numbering at least 10 in total, each of the first and second layers having an average thickness of less than about 500 nm, such that for substantially normally incident light and for a visible wavelength range of about 420 nm to about 680 nm:
for a first polarization state and at each of the first and second locations, the plurality of alternating first and second layers has an average optical reflectance of at least about 50%; and
for a second polarization state orthogonal to the first polarization state, the plurality of alternating first and second layers has an average optical reflectance of no more than about 10% for at least the first location, an absolute value of a difference in refractive indices of the first and second layers being 4, wherein:
at the first location, a minimum in the visible wavelength range of A occurs at a first wavelength of no more than 450 nm; and
at the second location, a minimum in the visible wavelength range of A occurs at a second wavelength at least about 10 nm greater than the first wavelength.

17. The optical construction of claim 16, wherein the first wavelength is no more than 440 nm and the second wavelength is in a range of about 450 nm to about 600 nm.

18. The optical construction of claim 16, wherein for substantially normally incident light, for the second polarization state, and for the first location, the refractive index of the first layer is less than the refractive index of the second layer for at least one wavelength in the visible wavelength range that is less than the first wavelength and the refractive index of the first layer is greater than the refractive index of the second layer for at least one wavelength in the visible wavelength range that is greater than the first wavelength.

19. The optical construction of claim 16, wherein for substantially normally incident light, for the second polarization state, and for the first location, the refractive index of the first layer is greater than the refractive index of the second layer for each wavelength in the visible wavelength range.

20. The optical construction of claim 16, wherein for the first location and for substantially normally incident light, a refractive index of the first layer along the first polarization state is less than a refractive index of the second layer along the first polarization state by at least about 0.05 for each wavelength in the visible wavelength range.

21. The optical construction of claim 16, wherein for substantially normally incident light, for the visible wavelength range, and for the second polarization state, the plurality of alternating first and second layers has first and second average optical reflectances at the respective first and second locations, the second average optical reflectance less than the first average optical reflectance.

22. The optical construction of claim 16, where for substantially normally incident light and for the second polarization state, the plurality of alternating first and second layers has an optical reflectance Rp, an average of the optical reflectance Rp in the visible wavelength range being no more than about 10% for at least the first location, wherein:
at the first location, a global minimum over the visible wavelength range of Rp occurs at a wavelength λp of no more than 450 nm; and
at the second location, a global minimum over the visible wavelength range of Rp occurs at a wavelength λp′ at least about 10 nm greater than the wavelength λp.

23. The optical construction of claim 16, wherein for substantially normally incident light and for the second polarization state, the plurality of alternating first and second layers has first and second average optical reflectances Rr and Rb for respective red and UV-blue wavelength ranges, each of the red and UV-blue wavelength ranges at least 20 nm wide, the red wavelength range disposed between about 600 nm and about 700 nm, the UV-blue wavelength range disposed between 380 nm and 450 nm, wherein at the first location, 5%≥Rr≥0.3% and Rb≤Rr/2.5.

24. A reflective polarizer comprising:
a plurality of alternating first and second layers numbering at least 10 in total, each of the first and second layers having an average thickness of less than about 500 nm, such that for substantially normally incident light and for a visible wavelength range of about 420 nm to about 680 nm:
for a first polarization state: the plurality of alternating first and second layers has an average optical reflectance of at least about 60%;
for a second polarization state orthogonal to the first polarization state:
the plurality of alternating first and second layers has an average optical reflectance of no more than about 5%; and
a minimum in the visible wavelength range of an absolute value of a difference in refractive indices of the first and second layers occurs at a first wavelength of no more than 450 nm.

25. The reflective polarizer of claim 24, wherein the refractive index of the first layer is less than the refractive index of the second layer for at least one wavelength in the visible wavelength range that is less than the first wavelength and the refractive index of the first layer is greater than the refractive index of the second layer for at least one wavelength in the visible wavelength range that is greater than the first wavelength.

26. The reflective polarizer of claim 24, wherein for substantially normally incident light and the second polarization state, the refractive index of the first layer is greater than the refractive index of the second layer for each wavelength in the visible wavelength range.

27. The reflective polarizer of claim 24, wherein for substantially normally incident light and the first polarization state, the plurality of alternating first and second layers has an optical reflectance versus wavelength comprising a band edge along which the optical reflectance generally decreases from greater than about 80% percent to less than about 20% with increasing wavelength, the band edge comprising a band edge wavelength where the optical reflectance is about 50%, the band edge wavelength being at least about 650 nm and no more than about 1000 nm.

28. The reflective polarizer of claim 24, wherein for substantially normally incident light, for the visible wavelength range, and for the second polarization state, the plurality of alternating first and second layers has an average optical reflectance of at least about 0.6%.

29. The reflective polarizer of claim 24, wherein for substantially normally incident light and for the second polarization state, the plurality of alternating first and second layers has an optical reflectance Rp, wherein a global minimum over the visible wavelength range of Rp occurs at a wavelength of no more than 450 nm.

30. The reflective polarizer of claim 24, wherein for substantially normally incident light and for the second polarization state, the plurality of alternating first and second layers has first and second average optical reflectances Rr and Rb for respective red and UV-blue wavelength ranges, each of the red and UV-blue wavelength ranges at least 20 nm wide, the red wavelength range disposed between about 600 nm and about 700 nm, the UV-blue wavelength range disposed between 380 nm and 450 nm, wherein 5% ≥Rr≥0.3% and Rb≤Rr/2.5.

31. A method of making an optical construction, the method comprising:
providing a reflective polarizer comprising a plurality of alternating first and second layers numbering at least 10 in total, each of the first and second layers having an average thickness of less than about 500 nm, such that for substantially normally incident light and a visible wavelength range of about 420 nm to about 680 nm, the reflective polarizer substantially reflects a first polarization state and substantially transmits an orthogonal second polarization state, wherein providing the reflective polarizer comprises selecting the first and second layers so that for substantially normally incident light and for the second polarization state, a minimum in the visible wavelength range of an absolute value of a difference in refractive indices of the first and second layers occurs at a first wavelength of no more than 450 nm; and
shaping the reflective polarizer into a predetermined shape curved about two orthogonal axes.

32. The method of claim 31, wherein the first wavelength is no more than 440 nm and after shaping the reflective polarizer into the predetermined shape, for at least one location of the reflective polarizer and for substantially normally incident light, a minimum in the visible wavelength range of an absolute value of a difference in refractive indices of the first and second layers along the second polarization state occurs at a second wavelength in a range of about 450 nm to about 600 nm.
